(19) United States
(12) Patent Application Publication
(10) Pub. No.: US 2026/0105519 A1
(43) Pub. Date: Apr. 16, 2026

(54) SYSTEM AND METHOD FOR AUTONOMOUS, NON-CUSTODIAL DIGITAL ASSET MANAGEMENT OF TOKENIZED EXCHANGE-TRADED PRODUCTS

(71) Applicant: WSCG, Inc., San Diego, CA (US)

(72) Inventor: Brian McLaren Foote, Del Mar, CA (US)

(21) Appl. No.: 19/357,331

(22) Filed: Oct. 14, 2025

Related U.S. Application Data
(60) Provisional application No. 63/708,225, filed on Oct. 16, 2024.

(51) Int. Cl. G06Q 40/04; H04L 9/40

(52) U.S. Cl. CPC G06Q 40/042; H04L 63/029; H04L 63/0428; G06Q 2220/00

(57) ABSTRACT

Systems and methods for non-custodial digital asset management. The system (100) comprising an ETP platform (104) for managing digital assets and a database (106) including a non-transitory computer-readable medium (110) including code and a controller (108) that executes the code, the controller (108) enabling communication between a user device (102) and the ETP platform (104), and a smart contract (112) that is connected to the database (106) via an application programming interface (114). A method for rebalancing digital assets within the system (100) for non-custodial digital asset management includes the steps of establishing initial ETP allocations in a portfolio, analyzing market conditions, executing smart contracts (112) to rebalance assets within the portfolio, identifying deviations from a target asset allocation, managing risk using risk management protocol during rebalancing, and continuously monitoring the portfolio.

### RELATED APPLICATION

This application claims priority on U.S. Provisional Application Ser. No. 63/708,225, filed on Oct. 16, 2024, and entitled “SYSTEM AND METHOD FOR NON-CUSTODIAL DIGITAL ASSET MANAGEMENT.” As far as permitted, the contents of U.S. Provisional Application Ser. No. 63/708,225 are incorporated in their entirety herein by reference.

### BACKGROUND

As trading markets become tokenized across multiple asset classes, instruments such as tokenized stocks, bonds, commodities, and precious metals, as well as real-world assets (RWAs), stablecoins, prediction-market positions, and cryptocurrencies, are increasingly issued and traded on distributed ledgers. In this environment, issuance, representation, and custodianship of assets span a variety of hosts, including issuers and transfer agents, asset owners and their wallets, centralized and decentralized digital exchanges, qualified custodians, and token registries. These hosts typically implement heterogeneous standards for access control, settlement, and compliance, complicating cross-venue portfolio management.

Conventional portfolio platforms often require investors to transfer assets to a custodial intermediary to implement strategies (e.g., rebalancing, order routing, and model-driven allocation). This approach creates custodial and concentration risk, reduces transparency, limits interoperability across tokenized exchanges, and introduces friction for regulated advisers (e.g., RIAs and BDs) seeking to deliver discretionary management without taking custody.

Existing tools for digital assets and ETPs generally lack autonomous cross-exchange orchestration under non-custodial constraints, do not consistently support multi-asset tokenized baskets, and provide limited on-chain auditability of compliance and strategy execution.

The management of digital assets, particularly in the form of exchange-traded products, presents unique challenges, and numerous issues are associated with the conventional management of digital assets. These problems include concentration and custodial-related risks, as well as inefficient portfolio management. In the broader digital asset ecosystem, reliance on specific digital assets or sectors introduces concentration risks if diversification is not adequately maintained and rebalanced during periods of extreme market fluctuations. Traditional systems often require users to transfer ownership of their assets to third parties, which creates security risks and introduces potential regulatory complications. Similarly, existing solutions for digital assets in exchange-traded products (“ETPs”) lack automated and dynamic tools for managing digital asset portfolios.

### SUMMARY

The present invention is directed toward a system for non-custodial digital asset management. In various embodiments, the system comprises an ETP platform for managing digital assets, and a database including a non-transitory computer-readable medium including code and a controller that executes the code, the controller enabling communication between a user device and the ETP platform, the database being connected to an encrypted tunnel that is configured to protect against unauthorized access to the system.

In certain embodiments, the system further comprises a smart contract that is connected to the database.

In various embodiments, the ETP platform provides real-time portfolio updates, the portfolio updates allowing for continuous alignment with market conditions and investment strategies.

In some embodiments, the system further comprises a blockchain that is integrated with the ETP platform.

In certain embodiments, the ETP platform includes compliance and monitoring tools that increase the likelihood that all transactions with the system comply with regulatory requirements by continuously monitoring activities within the system.

In various embodiments, the ETP platform includes an active rebalancing algorithm that is configured to analyze (i) market data and (ii) portfolio weights, and to generate updated allocation instructions to maintain target asset distributions.

In some embodiments, the ETP platform includes real-time data integration and aggregation.

In certain embodiments, the database includes a distributed database that stores one of (i) information related to user portfolios, (ii) market data, (iii) compliance records (e.g., KYC/AML), and (iv) transaction histories.

In various embodiments, the database includes an encrypted partition that is configured to store encrypted user data using a cryptographic key.

In some embodiments, the ETP platform is configured to rebalance digital assets according to an investment strategy.

The present invention is further directed toward a system for non-custodial digital asset management. In certain embodiments, the system comprises an ETP platform for managing digital assets, a database including a non-transitory computer-readable medium including code and a controller that executes the code, the controller enabling communication between a user device and the ETP platform, the database being connected to an encrypted tunnel that is configured to protect against unauthorized access to the system, and a smart contract that is connected to the database via an application programming interface.

In various embodiments, the smart contract is configured to (i) enforce business workflows in a decentralized manner, (ii) keep track of exchange accounts, rebalancing, and asset transactions, and (iii) orchestrate transfers within the system.

In some embodiments, the system further comprises a blockchain that is integrated with the ETP platform, the smart contract residing on the blockchain.

In certain embodiments, the smart contract autonomously governs workflow of the system by supporting execution and recording of various actions including one of (i) account registration, (ii) asset rebalancing, and (iii) asset purchases.

In various embodiments, the smart contract can be completed by a digital signature using crypto operations and a private key.

In some embodiments, the application programming interface includes an application programming interface gateway that is configured to aggregate real-time data.

In certain embodiments, the system further comprises cloud storage that interconnects a user device and the database.

In various embodiments, the system further comprises a dashboard that is connected to the ETP platform, the dashboard being viewable by a user to view their investments and portfolio.

In some embodiments, the system further comprises an exchange that allows for the transacting of digital assets within the ETP platform.

The present invention is further directed toward a system for non-custodial digital asset management. In certain embodiments, the system comprises an ETP platform for managing digital assets, a database including a non-transitory computer-readable medium including code and a controller that executes the code, the controller enabling communication between a user device and the ETP platform, the database being connected to an encrypted tunnel that is configured to protect against unauthorized access to the system, the database including a distributed database that stores one of (i) information related to user portfolios, (ii) market data, (iii) compliance records (e.g., KYC/AML), and (iv) transaction histories, a smart contract that is connected to the database via an application programming interface, the smart contract autonomously governing workflow of the system by supporting execution and recording of various actions including one of (i) account registration, (ii) asset rebalancing, and (iii) asset purchases, and a blockchain that is integrated with the ETP platform, the smart contract residing on the blockchain.

The present invention is also directed toward a method for user registration and portfolio setup for a user of a system for non-custodial digital asset management. In various embodiments, the method comprises the steps of creating a user account, loading funds onto a digital exchange, and selecting a digital asset.

In some embodiments, the step of creating a user account includes the user providing necessary information for KYC verification procedures.

In certain embodiments, the method further comprises the step of directing the user to subscribe to a subscription service associated with the system for non-custodial digital asset management.

In various embodiments, the step of selecting a digital asset includes the user selecting a desired investment strategy.

In some embodiments, the method further comprises the step of pasting the user's API keys to complete the subscription to the subscription service.

In certain embodiments, the method further comprises the step of selecting the desired investment amount.

In various embodiments, the method further comprises the step of completing the investment process.

In some embodiments, the method further comprises the step of monitoring user investments and portfolios by viewing a dashboard.

The present invention is further directed toward a method for rebalancing digital assets within a system for non-custodial digital asset management. In certain embodiments, the method comprises the steps of establishing initial ETP allocations in a portfolio, analyzing market conditions, and executing smart contracts to rebalance assets within the portfolio.

In various embodiments, the method further comprises the step of identifying deviations from a target asset allocation.

In some embodiments, the method further comprises the step of managing risk using risk management protocol during rebalancing.

In certain embodiments, the method further comprises the step of continuously monitoring the portfolio.

In various embodiments, the step of establishing initial ETP allocations includes reviewing initial allocations during portfolio setup.

In some embodiments, the step of establishing initial ETP allocations includes examining weights assigned to each digital asset based on factors including one of (i) market capitalization, (ii) trading volume, (iii) utility, and (iv) user risk tolerance.

In certain embodiments, the step of analyzing market conditions includes continuously monitoring market conditions using real-time data feeds.

In various embodiments, the step of analyzing market conditions includes tracking price movements, volatility, and emerging trends.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a block diagram depicting one embodiment of a system architecture for non-custodial digital asset management;

FIG. 2 is a flow chart depicting one embodiment of a method for user registration and portfolio setup for the system for non-custodial digital asset management; and

FIG. 3 is a flow chart depicting one embodiment of a method for rebalancing digital assets within the system for non-custodial digital asset management.

While embodiments of the present invention are susceptible to various modifications and alternative forms, specifics thereof have been shown by way of example and drawings, and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of systems and methods for managing exchange-traded products of digital assets non-custodially. The present disclosure also relates to computerized portfolio management systems, and more specifically, to the autonomous, non-custodial allocation, trading, and rebalancing of tokenized exchange-traded products (ETPs) across multiple tokenized exchanges, asset classes, and blockchain networks, while clients retain control of their funds. The system can include a user interface, a portfolio management engine, a blockchain integration module, and compliance and monitoring tools. The systems and methods described herein enable the application of index, active, sub-sector, and/or themed investment strategies to digital asset baskets, improving the security and efficient management of the digital assets without taking custody of the assets. Additionally, the systems and methods described herein manage customers' KYC/AML-compliant, custodial, digital exchange accounts to facilitate these strategies.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention, as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it is appreciated that such a development effort might be complex and time-consuming, but would nevertheless be a routine undertaking of engineering for those of ordinary skill in the art having the benefit of this disclosure.

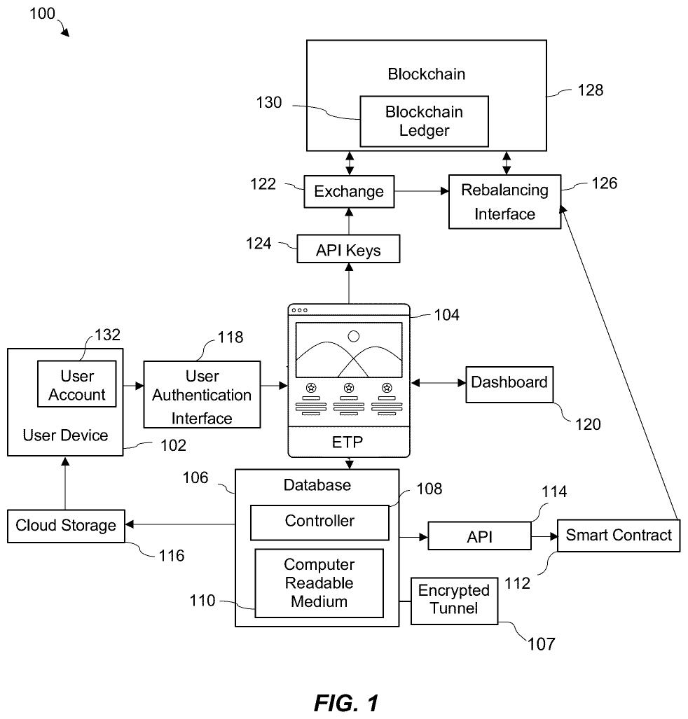

FIG. 1 is a block diagram depicting one embodiment of a system 100 architecture for non-custodial digital asset management. The system 100 can be implemented on a host system that can communicate with a network of user devices. The host system can include a database. The system 100 can vary depending on the design requirements of the system 100. It is understood that the financial services system 100 and host system can include additional systems, subsystems, components, and elements other than those specifically shown and/or described herein. Additionally, or alternatively, the system 100 and host system can omit one or more of the systems, subsystems, and elements that are specifically shown and/or described herein.

In the embodiment illustrated in FIG. 1, the system 100 can include a user device 102, an ETP platform 104, a database 106 including a controller 108 and a non-transitory computer-readable medium 110, a smart contract 112 that is connected to the database 106 via an application programming interface (“API”) 114, cloud storage 116, a user authentication interface 118, a dashboard 120, an exchange 122 that is connected to the ETP platform 104 via API keys 124, a rebalancing interface 126, and a blockchain 128 including a blockchain ledger 130. Users and/or agents can access the system 100 to utilize various services. In some embodiments, users can grant access to agents, including access to the users' sensitive user data. The system 100 can operate without access to client withdrawal privileges.

The user device 102 can be configured to communicate via a network (not shown). The user device 102 can communicate with the database 106 and the controller 108 to perform processes over the network. The user device 102 can vary depending on the design requirements of the system 100. It is understood that the user device 102 can include additional systems, subsystems, components, and elements other than those specifically shown and/or described herein. Additionally, or alternatively, the user device 102 can omit one or more of the systems, subsystems, and elements that are specifically shown and/or described herein.

For example, the user device 102 can include a computer, a user device processor, or a set of computers/processors. However, other types of computing units or systems can also be used. Exemplary user devices include servers, pooled servers, laptops, notebooks, handheld computers, personal digital assistants, cellular phones, smartphones (e.g., iPhone®, BlackBerry®, Android®, etc.), tablets, wearables (e.g., smartwatches and smart glasses), Internet of Things (IoT) devices or any other device capable of receiving data over a network.

The user device 102 can include any device capable of receiving and displaying electronic messages via the network, communicating with the ETP platform 104, and interacting with the blockchain 128. In certain embodiments, each user device 102 can include an encrypted partition configured to store encrypted user data using a cryptographic key.

As used herein, the term “network” encompasses any cloud, cloud computing system, electronic communications system, or method that incorporates hardware and/or software components. Communication among the parties can be accomplished through any suitable communication channels, such as, for example, a telephone network, an extranet, an intranet, the internet, point of interaction device (point of sale device, personal digital assistant, cellular phone, kiosk, tablet, etc.), online communications, satellite communications, off-line communications, wireless communications, transponder communications, local area network (LAN), wide area network (WAN), a virtual private network (VPN), networked or linked devices, keyboard, mouse and/or any suitable communication or data input modality.

Moreover, although the system 100 is described herein as being implemented with TCP/IP communications protocols, the system can also be implemented using IPX, Appletalk, IP-6, NetBIOS, OSI, any tunneling protocol (e.g., IPsec, SSH), or any number of existing or future protocols. If the network is in the nature of a public network, such as the Internet, it can be advantageous to assume the network is insecure and open to eavesdroppers.

A network can be unsecure. Thus, communication over the financial services system 100 can utilize data encryption. Encryption can be performed by way of any of the techniques now available in the art or which can become available—e.g., Twofish, RSA, El Gamal, Schorr signature, DSA, PGP, PKI, GPG (GnuPG), and symmetric and asymmetric cryptosystems, as non-exclusive examples. Asymmetric encryption, in particular, can be implemented for signing and verifying signatures for blockchain crypto operations.

The ETP platform 104 includes a non-custodial management platform for exchange-traded products (“ETPs”), which are composed of digital assets. ETPs may include constituents from tokenized stocks, digital assets/cryptocurrencies, RWAs, stablecoins, precious metals, and prediction-market instruments. Each constituent can include target weight, rebalance bands, venue preferences, liquidity thresholds, and compliance tags (e.g., “US-eligible only”). The system 100 and the ETP platform 104 enable users to maintain control over their digital assets while benefiting from automated rebalancing and professional investment strategies. The ETP platform 104 provides real-time portfolio updates, allowing for continuous alignment with market conditions and investment strategies without manual intervention. Via the blockchain 128 integration, digital asset data, security, and regulatory risks are reduced when compared to other custodial investment solutions.

The ETP platform 104 can vary depending on the design requirements of the financial services system 100, the user device 102, and the blockchain 128. It is understood that the ETP platform 104 can include additional systems, subsystems, components, and elements other than those specifically shown and/or described herein. Additionally, or alternatively, the ETP platform 104 can omit one or more of the systems, subsystems, and elements that are specifically shown and/or described herein.

The ETP platform 104 can include compliance and monitoring tools (KYC/AML) that increase the likelihood that all transactions comply with regulatory requirements, such as KYC and AML, by continuously monitoring activities. This reduces regulatory risk and helps reduce the risk of fraud, which is critical for the widespread adoption of digital assets. The ETP platform 104 can also integrate with the user's KYC/AML-compliant, custodial, digital exchange accounts to facilitate the secure and compliant management of digital assets. The monitoring tools can continuously track the index to detect and reduce the risk of manipulation and unauthorized access. Regular audits can be conducted to increase the integrity and security of the system 100. The compliance and monitoring tooks can check: (i) KYC/AML status; (ii) jurisdictional allowlists; (iii) asset and venue sanctions/allowlists; (iv) position and notional limits; and/or (v) reporting thresholds. A policy proof (e.g., a hash of the policy version and evaluation results) and the signed trade intent can be recorded on the blockchain ledger 130. This can yield verifiable, immutable audit trails for supervisory review and oversight.

The ETP platform 104 can include an active rebalancing algorithm that applies index, active, and sub-sector or themed investment strategies to digital asset baskets. The ETP platform 104 can improve optimal asset allocations based on market conditions and customer preferences. The ETP platform 104 can periodically rebalance the portfolio to improve optimal asset allocations. The active rebalancing algorithm can generate proposed weights using features such as: rolling volatility, correlation matrices, liquidity scores, drawdown risk, event signals, on-chain activity, and venue reliability. Proposals can be filtered through policy rules and user risk models. Approved proposals can be translated into executable orders (e.g., market/limit/TWAP/VWAP) and submitted via trade-only APIs or smart-contract calls. The active rebalancing algorithm can automatically adjust asset allocations within user portfolios.

The ETP platform 104 can include a blockchain integration module for integration with the blockchain 128. The blockchain integration module integrates with various blockchain networks associated with blockchain 128 to facilitate the non-custodial management of digital assets, thereby increasing the transparency, immutability, and security of transaction data.

The ETP platform 104 can include real-time data integration and aggregation. The data aggregation module collects real-time data from various sources, increasing the accuracy and timeliness of the data used in the index calculation. The ETP platform 104 is continuously updated in real-time based on the latest data. For example, the ETP platform 104 can record the current prices of digital assets and query user accounts to retrieve balances of each digital asset at specified time intervals (such as twice daily).

The database 106 can include a distributed database that stores information related to user portfolios, market data, compliance records (e.g., KYC/AML), and transaction histories. The distributed database storage process confirms that the system 100 maintains an accurate and auditable record of all operations. In certain embodiments, the database 106 can include an audit ledger. The distributed-ledger recordkeeping and cryptographic key isolation enhance the integrity and security of the system 100.

The database 106, including the controller 108, can control all of the functionality of the system 100. The database 106 can send and receive any or all of the data within the system 100. The database 106 can integrate with one or more of the elements of the system 100, and the database 106 facilitates transactions within the system. The database 106 can control, facilitate, and/or administrate all of the processes, functions, elements, and components within the system 100. The database 106 can achieve one or more functions of the system 100.

The database 106 can vary depending on the design requirements of the financial services system 100, the user device 102, and the blockchain 128. It is understood that the database 106 can include additional systems, subsystems, components, and elements other than those specifically shown and/or described herein. Additionally, or alternatively, the database 106 can omit one or more of the systems, subsystems, and elements that are specifically shown and/or described herein.

In the embodiment illustrated in FIG. 1, the database 106 can include a controller 108 and a non-transitory computer-readable medium 110. In certain embodiments, the database 106 can include an encrypted partition configured to store encrypted user data using a cryptographic key. Additionally, or in the alternative, the database 106 can be connected to an encrypted tunnel 107 configured to protect against and reduce the risk of unauthorized access to the system 100. In certain embodiments, the encrypted tunnel 107 can include a TLS-secured RPC channel.

The controller 108 can control, facilitate, and/or administrate all of the processes, functions, elements, and components within the system 100. The controller 108 can achieve one or more functions of the system 100. The controller 108 can enable communication between the user device 102 and the ETP platform 104.

The controller 108 can vary depending on the design requirements of the financial services system 100 and/or the database 106. It is understood that the controller 108 can include additional systems, subsystems, components, and elements other than those specifically shown and/or described herein. Additionally, or alternatively, the controller 108 can omit one or more of the systems, subsystems, and elements that are specifically shown and/or described herein. The controller 108 can include any number of computer units, processors, systems, devices, and/or components necessary to perform the functions of the database 106 and/or controller 108 within the system 100.

The controller 108 can include a verifiable orchestration layer enabling cross-exchange execution without user intervention. The orchestration layer can evaluate deviations from target allocation and, when thresholds are met, prepare cross-exchange orders that respect non-custodial constraints. This cross-exchange, multi-asset orchestration can integrate tokenized equities, cryptocurrencies, real-world assets, stablecoins, and prediction-market instruments under one automated ETP framework. The orchestration layer can provide interoperability across different custodial hosts (issuers, exchanges, wallets, or owner-held tokens), solving a problem that existing systems cannot address due to incompatible standards and custody models.

The controller 108 can include a best-execution router that selects venues based on spread, depth, latency, and fee models. The best-execution router can include an autonomous non-custodial execution layer that can execute trading and rebalancing across multiple digital exchanges using delegated API access and on-chain smart contracts.

The non-transitory computer-readable medium 110 can store computer program instructions. The non-transitory computer-readable medium 110 can vary depending on the design requirements of the system 100 and/or the controller 108. It is understood that the non-transitory computer-readable medium 110 can include additional systems, subsystems, components, and elements other than those specifically shown and/or described herein. Additionally, or alternatively, the non-transitory computer-readable medium 110 can omit one or more of the systems, subsystems, and elements that are specifically shown and/or described herein.

The non-transitory computer-readable medium 110 can be a tangible computer-readable carrier, such as a magnetic or optical memory or a magnetic or optical disk, as non-exclusive, non-limiting examples. The non-transitory computer-readable medium 110 can include any number of computer units, processors, systems, devices, and/or components necessary to perform the functions of the database 106 and/or the controller 108 within the system 100.

The smart contract 112 can be used with the system 100. The system 100 can enable smart contracts 112 that enforce business workflows in a decentralized manner, keeping track of exchange accounts, rebalancing, and asset transactions. The transfers made within the system 100 can be orchestrated using the smart contract 112. The smart contract 112 can reside on the blockchain 128, but also can exist external to the blockchain 128, such as shown in FIG. 1.

The smart contract 112 can autonomously govern the workflow of the system 100 by supporting execution and recording of various actions such as account registration, asset rebalancing, asset purchases/sales, or other related actions. The smart contract 112 automates the rebalancing of asset portfolios, increasing the likelihood of timely adjustments based on predefined rules without manual intervention. The automated rebalancing reduces errors, improves efficiency, and increases the likelihood that portfolios stay aligned with market conditions.

For digital assets, current prices can be retrieved, and the percentage weight of each digital asset for a selected fiat currency can be calculated based on the digital asset balance and pricing. The calculated basket weight can then be compared to a predetermined target distribution (e.g., 40%:30%:30% for digital assets A, B, and C, respectively). If any digital asset's percentage weight exceeds its target by a specified threshold (e.g., ±5%), it can be marked as requiring rebalancing.

For digital assets that require rebalancing, a new table entry can be created to record the rebalancing action, including: (1) the current price and balance of each digital asset, (2) the target distribution for the basket, and (3) the digital assets identified as requiring rebalancing. To undergo rebalancing, excess digital assets are then sold by identifying the excess digital assets that exceed their target percentage weight and executing a sell order to dispose of these excess digital assets and convert their value into a selected fiat currency. After the excess digital assets are sold, using the funds generated from selling excess digital assets, investments are made in the underweight digital assets to bring them back up to their target distribution.

The smart contract 112 can control the end-to-end flow of the system. The smart contract 112 can be configured to maintain accounting for various user accounts by keeping a historical record of transactions and balances. The smart contract 112 can include a program written in a programming language, such as Solidity, or any other suitable programming language. The smart contracts 112 can be completed by a digital signature using asymmetric crypto operations and a private key, for example.

The smart contract 112 can vary depending on the design requirements of the system 100, the user device 102, the ETP platform 104, the database 106, and/or the blockchain 128. It is understood that the smart contract 112 can include additional systems, subsystems, components, and elements other than those specifically shown and/or described herein. Additionally, or alternatively, the smart contract 112 can omit one or more of the systems, subsystems, and elements that are specifically shown and/or described herein. As provided in greater detail herein, the smart contract 112 communicates with the host database 115 to perform the functions identified herein.

The application programming interface 114 (“API”) can connect with the ETP Platform 104, the database 106, the smart contract 112, and/or the blockchain 128. The API 114 can be utilized in the form of an API 114 gateway to connect with the smart contract 112 and the exchange 122 (via API Keys 124), where the user grants read-only (non-withdrawal) access. These API 114 gateways improve real-time data aggregation, allowing the system 100 to monitor market conditions and execute trades when necessary continuously. In certain embodiments, the API 114 can include exchange API keys that are configured with trade-only scope and withdrawal endpoints are disabled. In certain embodiments, the system 100 can utilize trade-only API scopes and on-chain authorization tokens that cryptographically restrict any withdrawal or transfer functions, ensuring that users retain exclusive custody of all assets.

The API 114 can vary depending on the design requirements of the system 100, the user device 102, the ETP platform 104, the database 106, the smart contract 112, and/or the blockchain 128. It is understood that the API 114 can include additional systems, subsystems, components, and elements other than those specifically shown and/or described herein. Additionally, or alternatively, the API 114 can omit one or more of the systems, subsystems, and elements that are specifically shown and/or described herein.

The cloud storage 116 interconnects and/or allows for communication between the user device 102 and the database 106. “Cloud Storage” 116, “Cloud,” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing can include location-independent computing, whereby shared servers provide resources, software, and data to computers and other devices on demand.

The cloud storage 116 can vary depending on the design requirements of the system 100, the user device 102, the ETP platform 104, the database 106, the smart contract 112, and/or the blockchain 128. It is understood that the cloud storage 116 can include additional systems, subsystems, components, and elements other than those specifically shown and/or described herein. Additionally, or alternatively, the cloud storage 116 can omit one or more of the systems, subsystems, and elements that are specifically shown and/or described herein.

The user authentication interface 118 interfaces and/or interconnects the user device 102 with the ETP platform 104, upon authentication of the user device 102. The user authentication interface 118 can vary depending on the design requirements of the system 100, the user device 102, the ETP platform 104, the database 106, the smart contract 112, and/or the blockchain 128. It is understood that the user authentication interface 118 can include additional systems, subsystems, components, and elements other than those specifically shown and/or described herein. Additionally, or alternatively, the user authentication interface 118 can omit one or more of the systems, subsystems, and elements that are specifically shown and/or described herein.

The dashboard 120 is viewable by a user to view their investments and portfolio. The dashboard 120 includes a user interface that provides users with an intuitive, real-time interface to monitor investments. The dashboard 120 gives users transparency, control, and the ability to make quick adjustments when necessary. The dashboard 120 can include a web-based or mobile application that allows users to interact with the ETP platform 104. The dashboard 120 can include a web-based or mobile application that allows customers to interact with the system 100, providing real-time portfolio updates, performance metrics, and investment options.

The dashboard 120 can vary depending on the design requirements of the system 100, the user device 102, the ETP platform 104, the database 106, the smart contract 112, and/or the blockchain 128. It is understood that the dashboard 120 can include additional systems, subsystems, components, and elements other than those specifically shown and/or described herein. Additionally, or alternatively, the dashboard 120 can omit one or more of the systems, subsystems, and elements that are specifically shown and/or described herein.

The exchange 122 allows for the transacting of digital assets within the ETP platform 104. The exchange 122 can vary depending on the design requirements of the system 100, the user device 102, the ETP platform 104, the database 106, the smart contract 112, and/or the blockchain 128. It is understood that the exchange 122 can include additional systems, subsystems, components, and elements other than those specifically shown and/or described herein. Additionally, or alternatively, the exchange 122 can omit one or more of the systems, subsystems, and elements that are specifically shown and/or described herein.

The API Keys 124 are used by a user to complete a subscription and select a desired investment amount. The API Keys 124 interconnect the ETP platform 104 and the exchange 122. The API Keys 124 can vary depending on the design requirements of the system 100, the user device 102, the ETP platform 104, the database 106, the exchange 122, and/or the blockchain 128. It is understood that the API Keys 124 can include additional systems, subsystems, components, and elements other than those specifically shown and/or described herein. Additionally, or alternatively, the API Keys 124 can omit one or more of the systems, subsystems, and elements that are specifically shown and/or described herein.

The rebalancing interface 126 facilitates the rebalancing of assets purchased on the exchange 122 via the smart contract 112. The rebalancing interface 126 can vary depending on the design requirements of the system 100, the user device 102, the ETP platform 104, the database 106, the exchange 122, and/or the blockchain 128. It is understood that the rebalancing interface 126 can include additional systems, subsystems, components, and elements other than those specifically shown and/or described herein. Additionally, or alternatively, the rebalancing interface 126 can omit one or more of the systems, subsystems, and elements that are specifically shown and/or described herein.

The blockchain 128 can be used within the system 100. The blockchain 128 is a distributed database that maintains records in a readable manner, and that is also resistant to tampering and provides immutability. In the context of the system 100, the blockchain 113 can include the digital ledger 128 containing transactions conducted on the system 100, including digital asset transactions and rebalancing.

The blockchain 128 can comprise a system of interconnected blocks containing data. The blockchain 128 can include one or more blockchains, and the blockchains can act in unison to function as a single blockchain 128. The blocks can hold transaction data, contract data, and/or other information as desired. Each block can link to the previous block and can include a timestamp. The blockchain 128 can be a peer-to-peer network that is private, consortium, and/or public in nature (e.g., Ethereum, Bitcoin, etc.). Consortium and private networks can offer improved control over the content of the blockchain 128, and public networks can leverage the cumulative computing power of the network to improve security.

The blockchain 128 can be based on blockchain technologies such as, for example, Ethereum, Open Chain, Chain Open Standard, etc. The blockchain 128 can autonomously manage workflows associated with asset rebalancing as described in greater detail herein, reducing the processing load on the user devices 102 within the system.

The blockchain 128 can vary depending on the design requirements of the system 100, the user device 102, the ETP platform 104, the database 106, and/or the smart contract 112. It is understood that the blockchain 128 can include additional systems, subsystems, components, and elements other than those specifically shown and/or described herein. Additionally, or alternatively, the blockchain 128 can omit one or more of the systems, subsystems, and elements that are specifically shown and/or described herein. As provided in greater detail herein, the blockchain 128 communicates with the ETP platform 104 and the database 106 to perform the functions identified herein.

The blockchain 128 can include a blockchain ledger 130 that is configured to execute payment transactions in response to blockchain requests. The blockchain ledger 130 can be based on the blockchain 128 and thus have consensus-based transaction validation and immutability. When implemented in support of a system 100, the blockchain ledger 130 can serve as a ledger for transfers of digital assets, digital currencies, contracts, offers, and other suitable data retained in the blockchain 128.

The blockchain ledger 130 can record all transactions conducted within the system 100. When implemented in support of the system 100, the blockchain ledger 130 can serve as a ledger for transfers of funds, contracts (including smart contracts 112), offers, loans, liens, and other suitable data retained in the blockchain 130. The blockchain ledger 130 provides transparent, secure, and immutable records of all transactions and portfolio adjustments. The blockchain 128 and the blockchain ledger 130 increase the likelihood that the system 100 operates in a trustless environment, bolstering security and accountability.

The blockchain ledger 130 can vary depending on the design requirements of the financial services system 100, the user device 102, the ETP platform 104, the database 106, and/or the blockchain 128. It is understood that the blockchain ledger 130 can include additional systems, subsystems, components, and elements other than those specifically shown and/or described herein. Additionally, or alternatively, the blockchain ledger 130 can omit one or more of the systems, subsystems, and elements that are specifically shown and/or described herein. As provided in greater detail herein, the blockchain ledger 130 communicates with the database 106 to perform the functions identified herein.

The user account 132, located on the user device 102, includes the credentials and funding information necessary to complete investments and blockchain functionality in the system 100. The user account 132 can vary depending on the design requirements of the system 100, the user device 102, the ETP platform 104, the database 106, and/or the blockchain 128. It is understood that the user account 132 can include additional systems, subsystems, components, and elements other than those specifically shown and/or described herein. Additionally, or alternatively, the user account 132 can omit one or more of the systems, subsystems, and elements that are specifically shown and/or described herein.

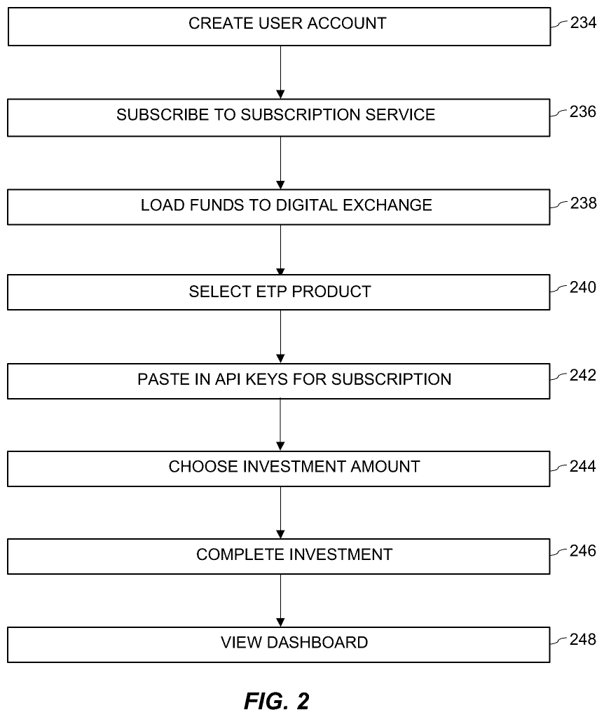

FIG. 2 is a flow chart depicting one embodiment of a method for user registration and portfolio setup for the system for non-custodial digital asset management, which can include one or more of the following steps. It is understood that the method can include additional steps than those specifically shown and/or described herein. Additionally, or alternatively, the method can omit one or more of the steps that are specifically shown and/or described herein. The method for user registration and portfolio setup for the system for non-custodial digital asset management can be implemented on the system 100 (illustrated in FIG. 1), or other systems and subsystems not specifically shown and/or described herein. It is understood that the method shown and/or described herein can be controlled by the controller 108 or other components of the database 106. In other words, the method can be enabled by the system 100 via the controller 108.

At step 234, a user creates a user account to engage with the system 100. The registration process can include the user providing the necessary information for KYC verification procedures.

At step 236, the user is directed to subscribe to the subscription service associated with the system 100.

At step 238, the user loads funds onto a digital exchange.

At step 240, the user selects the Block ETP product they wish to use. The user can select and/or set up their portfolio by selecting desired investment strategies (index, active, sub-sector, or themed) and specifying their investment preferences.

In certain embodiments, the investment strategies can include index-based strategies to digital asset baskets, tracking the performance of a predefined set of assets. The portfolio management engine can rebalance the assets within the digital asset basket based on the index-based strategy. Rebalancing is used to maintain alignment with the selected index.

In various embodiments, the investment strategies can include an active investment strategy. The active investment strategy allows for dynamic asset allocation based on market conditions and AI-driven insights. The portfolio management engine can adjust the asset allocation in real-time to capitalize on market opportunities.

In some embodiments, the investment strategies can include sub-sector or themed strategies. The system can apply sub-sector or themed investment strategies, focusing on specific segments of the digital asset market. The portfolio management engine can tailor the asset allocation to align with the chosen sub-sector or theme, improving optimization for growth and risk management.

In certain embodiments, the investment strategies can include a multi-factorial index calculation. The system can calculate the index based on a blend of technical metrics such as market cap and trading volume, and other factors such as social media activity, community size, on-chain transaction data, and historical performance. The index calculation engine improves the optimization of the weighting of each factor to provide a well-calibrated assessment of the digital asset markets.

In various embodiments, the investment strategies can include a customizable index weighting. The user interface allows users to customize the weighting of factors based on their investment strategies and risk tolerance. The system provides real-time feedback on the impact of different weightings on the index performance.

At step 242, the user pastes their API keys to complete the subscription.

At step 244, the user selects their desired investment amount.

At step 246, the investment process is completed. The portfolio management engine of the system 100 can allocate digital assets according to the selected strategies and preferences.

At step 248, the users can monitor their investments and view the dashboard to see their portfolio.

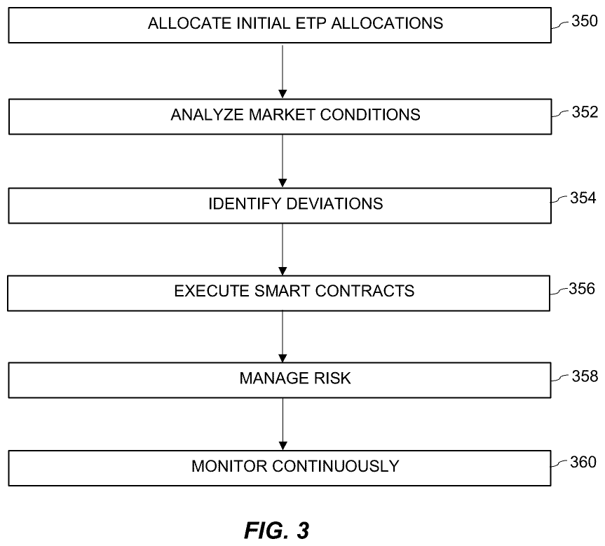

FIG. 3 is a flow chart depicting one embodiment of a method for rebalancing digital assets within the system for non-custodial digital asset management, which can include one or more of the following steps. It is understood that the method can include additional steps than those specifically shown and/or described herein. Additionally, or alternatively, the method can omit one or more of the steps that are specifically shown and/or described herein. The method for user registration and portfolio setup for the system for non-custodial digital asset management can be implemented on the system 100 (illustrated in FIG. 1), or other systems and subsystems not specifically shown and/or described herein. It is understood that the method shown and/or described herein can be controlled by the controller 108 or other components of the database 106. In other words, the method can be enabled by the system 100 via the controller 108.

At step 350, initial ETP allocations are allocated and established. The system 100 continuously monitors these allocations. The system 100 begins by reviewing the initial allocations set during the portfolio setup. The initial allocation process includes examining the weights assigned to each digital asset based on factors such as market capitalization, trading volume, utility, and the user's risk tolerance.

At step 352, market conditions are analyzed. This analysis includes the portfolio management engine continuously monitors market conditions using real-time data feeds. The analysis process also includes tracking price movements, volatility, and emerging trends. The system 100 also assesses the regulatory environment and any significant news that may impact the portfolio's performance.

The rebalancing steps, 352-360, utilize smart contract analysis to dynamically adjust asset allocations from their initial allocations. The smart contract process adjusts the portfolio so that it remains aligned with market conditions and the user's selected investment strategies, providing real-time adjustments to optimize performance and manage risk. The system 100 periodically evaluates the portfolio's composition against predefined benchmarks and triggers adjustments to improve performance.

At step 354, deviations are identified from the target asset allocation. For example, if a particular asset has appreciated significantly and now occupies a larger percentage of the portfolio than intended, the system flags this as a rebalancing opportunity.

At step 356, smart contracts are executed. The rebalancing process is executed via smart contracts. These contracts automatically adjust the portfolio by selling over-allocated assets and buying under-allocated ones. The smart contracts allow rebalancing without manual intervention, increasing the likelihood of quick and accurate adjustments.

At step 358, the risk is managed using risk management protocols during rebalancing. The risk management protocols evaluate the potential impact of the trades on the overall portfolio risk profile and evaluate whether the rebalancing actions introduce undue volatility.

At step 360, the system continuously monitors the portfolio. This continuous monitoring evaluates the adjustments to see if they have the desired effect. If further rebalancing is necessary due to sudden market changes, the system is on standby to rebalance.

The primary technical problem identified when attempting to use conventional technologies to manage exchange-traded products (ETPs) for digital assets includes (1) Custodial Risks and Inefficiency, and (2) Manual and Fragmented Portfolio Management.
Custodial Risks and Inefficiency: Conventional solutions require users to transfer ownership of their assets to a custodian, which can introduce significant security risks and create regulatory complexities. Users lose control over their assets, making these systems inefficient for decentralized digital assets, where the emphasis is on ownership and control of your coins.
Manual and Fragmented Portfolio Management: Existing technologies often require manual portfolio management and rebalancing, which can be time-consuming, prone to errors, and inefficient in volatile markets. The lack of automated tools for continuous optimization creates gaps in maximizing portfolio performance and managing risks.

The technical solutions of the disclosed technology improve functionality by enhancing security through non-custodial management and blockchain integration, making transactions more secure and transparent. Automated smart contracts increase system efficiency and speed by eliminating manual intervention and enabling real-time decision-making. Additionally, real-time data processing and automated compliance tools streamline operations, increasing the likelihood of faster, more accurate, and secure digital asset management. Other technical improvements to the disclosed computer-implemented digital-asset systems include (a) a verifiable orchestration layer enabling cross-exchange execution without human intervention, (b) deterministic smart-contract enforcement replacing manual custodial reconciliation, and (c) enhanced system integrity via distributed-ledger recordkeeping and cryptographic key isolation. These concrete, technological implementations are directed toward improving computers and computer-based systems.

The technical benefits of the disclosed technology include enhanced security through non-custodial management, allowing users to retain control of their assets and diversified asset exposure. The integration of blockchain provides transparency and trust, while built-in compliance tools increase the likelihood of seamless regulatory adherence. Unlike conventional trading or rebalancing software, the disclosed system introduces a verifiable non-custodial orchestration layer that enforces deterministic execution of multiasset, multi-exchange rebalancing orders through on-chain smart-contract proofs. This architecture improves the functioning of distributed computer networks by eliminating off-chain reconciliation, reducing message latency, and providing cryptographic verification of trade intent. The improvement is therefore technical in nature, increasing system reliability and auditability across heterogeneous blockchain and exchange environments.

Because transactions within the systems and methods disclosed herein can be cryptographically hashed and otherwise encrypted, the security and privacy of user data are increased. Additionally, system data can be stored on established PostgreSQL database platforms, in a high availability configuration, with the option for geo-redundancy. All system information is encrypted (cell-level encryption) using the industry's standard AES-256. The cryptographic keys used to encrypt the user data are stored on an encrypted partition. Web services are accessed through an encrypted tunnel between the servers and Cloudflare™. Servers can run the Ubuntu server operating system, hardened according to the latest Center for Internet Security benchmarks. The system may be implemented using distributed services with hardened key management; encrypted at rest (e.g., AES-256) and in transit (e.g., TLS). The system can be agnostic to chain (e.g., EVM, non-EVM) and exchange type (centralized, decentralized, permissioned), provided non-custodial execution guarantees are upheld.

A digital asset investment system based on a blockchain, as described herein, can simplify investment platforms by using the blockchain as a ledger. Transparency is very high for various embodiments using a consortium or public blockchain since accounting is performed, for example, by a decentralized autonomous organization (DAO) instead of a specific financial institution.

Systems, methods and computer program products are provided. In the detailed description herein, references to “various embodiments,” “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases do not necessarily refer to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described. After reading the description, it will be apparent to one skilled in the relevant art(s) how to implement the disclosure in alternative embodiments.

In various embodiments, the methods described herein are implemented using the various particular machines described herein. The methods described herein can be implemented using the below particular machines, and those hereinafter developed, in any suitable combination, as would be appreciated immediately by one skilled in the art. Further, as is unambiguous from this disclosure, the methods described herein can result in various transformations of certain articles.

For the sake of brevity, conventional data networking, application development and other functional aspects of the systems (and components of the individual operating components of the systems) cannot be described in detail herein. Furthermore, the connecting lines shown in the various figures contained herein are intended to represent exemplary functional relationships and/or physical couplings between the various elements. It should be noted that many alternative or additional functional relationships or physical connections can be present in a practical system.

The various system components discussed herein can include one or more of the following: a host server or other computing systems, including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein can include: client data, merchant data, financial institution data, and/or like data useful in the operation of the system. As those skilled in the art will appreciate, user computer can include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof can be implemented using hardware, software or a combination thereof and can be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations can be machine operations. Useful machines for performing the various embodiments include general-purpose digital computers or similar devices.

In fact, in various embodiments, the embodiments are directed toward one or more computer systems capable of carrying out the functionality described herein. The computer system includes one or more processors, such as a processor. The processor is connected to a communication infrastructure (e.g., a communications bus, crossover bar, or network). Various software embodiments are described in terms of this exemplary computer system. After reading this description, it will become apparent to a person skilled in the relevant art(s) how to implement various embodiments using other computer systems and/or architectures. A computer system can include a display interface that forwards graphics, text, and other data from the communication infrastructure (or from a frame buffer not shown) for display on a display unit.

The computer system also includes a main memory, such as, for example, random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage unit in a well-known manner. A removable storage unit represents a floppy disk, magnetic tape, optical disk, etc., which is read by and written to by a removable storage drive. As will be appreciated, the removable storage unit includes a computer usable storage medium having stored therein computer software and/or data.

In various embodiments, secondary memory can include other similar devices for allowing computer programs or other instructions to be loaded into a computer system. Such devices can include, for example, a removable storage unit and an interface. Examples of such can include a program cartridge and cartridge interface (such as that found in video game devices), a removable memory chip (such as an erasable programmable read-only memory (EPROM), or programmable read-only memory (PROM)) and associated socket, and other removable storage units and interfaces, which allow software and data to be transferred from the removable storage unit to computer system.

The computer system can also include a communications interface. The communications interface allows software and data to be transferred between a computer system and external devices. Examples of communications interfaces can include a modem, a network interface (such as an Ethernet card), a communications port, a Personal Computer Memory Card International Association (PCMCIA) slot and card, etc. Software and data transferred via communications interface are in the form of signals, which can be electronic, electromagnetic, optical or other signals capable of being received by the communications interface. These signals are provided to the communications interface via a communications path (e.g., channel). This channel carries signals and can be implemented using wire, cable, fiber optics, a telephone line, a cellular link, a radio frequency (RF) link, wireless and other communications channels.

The terms “computer program medium,” “computer usable medium,” and “computer-readable medium” are used to generally refer to media such as a removable storage drive and a hard disk installed in a hard disk drive. These computer program products provide software to computer systems.

Computer programs (also referred to as computer control logic) are stored in main memory and/or secondary memory. Computer programs can also be received via a communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, the software can be stored in a computer program product and loaded into a computer system using a removable storage drive, hard disk drive or communications interface. The control logic (software), when executed by the processor, causes the processor to perform the functions of various embodiments as described herein. In various embodiments, hardware components such as application-specific integrated circuits (ASICs) are used. Implementation of the hardware state machine so as to perform the functions described herein will be apparent to persons skilled in the relevant art(s).

In various embodiments, the server can include application servers (e.g., WebSphere, WebLogic, JBOSS). In various embodiments, the server can include web servers (e.g., APACHE, IIS, GWS, SUN JAVA® SYSTEM WEB SERVER).

A web client includes any device (e.g., personal computer) that communicates via any network, for example, such as those discussed herein. Such browser applications comprise Internet browsing software installed within a computing unit or a system to conduct online transactions and/or communications. These computing units or systems can take the form of a computer or a set of computers. However, other types of computing units or systems can be used, including laptops, notebooks, tablets, handheld computers, personal digital assistants, set-top boxes, workstations, computer-servers, mainframe computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web client can run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client can or cannot be in direct contact with an application server, such as a digital wallet hub. For example, a web client can access the services of an application server through another server and/or hardware component, which can have a direct or indirect connection to an Internet server. For example, a web client can communicate with an application server via a load balancer. In various embodiments, access is through a network or the Internet through a commercially available web browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client can include any suitable personal computer, network computer, workstation, personal digital assistant, cellular phone, smartphone, mini-computer, mainframe or the like. A web client can be in a home or business environment with access to a network. In various embodiments, access is through a network or the Internet through a commercially available web browser software package. A web client can implement security protocols such as Secure Sockets Layer (SSL) and Transport Layer Security (TLS). A web client can implement several application layer protocols, including HTTP, https, ftp, and sftp.

In various embodiments, components, modules, and/or engines of the financial services system can be implemented as micro-applications or micro-apps. Micro-apps are typically deployed in the context of a mobile operating system, including, for example, a WINDOWS® mobile operating system, an ANDROID® Operating System, APPLE® IOS®, a BLACKBERRY® operating system and the like. The micro-app can be configured to leverage the resources of the larger operating system and associated hardware via a set of predetermined rules that govern the operations of various operating systems and hardware resources. For example, where a micro-app desires to communicate with a device or network other than the mobile device or mobile operating system, the micro-app can leverage the communication protocol of the operating system and associated device hardware under the predetermined rules of the mobile operating system. Moreover, where the micro-app desires an input from a user, the micro-app can be configured to request a response from the operating system, which monitors various hardware components and then communicates a detected input from the hardware to the micro-app.

As used herein, “transmit” can include sending electronic data from one system component to another over a network connection. Additionally, as used herein, “data” can include encompassing information such as commands, queries, files, data for storage, and the like in digital or any other form.

Any databases discussed herein can include relational, hierarchical, graphical, or object-oriented structures and/or any other database configurations. Common database products that can be used to implement the databases include DB2 by IBM® (Armonk, N.Y.), various database products available from ORACLE. Corporation (Redwood Shores, Calif.), MICROSOFT® Access® or MICROSOFT® SQL Server, by MICROSOFT® Corporation (Redmond, Wash.), MySQL by MySQL AB (Uppsala, Sweden), or any other suitable database product. Moreover, the databases can be organized in any suitable manner, for example, as data tables or lookup tables. Each record can be a single file, a series of files, a linked series of data fields or any other data structure. The association of certain data can be accomplished through any desired data association technique, such as those known or practiced in the art. For example, the association can be accomplished either manually or automatically. Automatic association techniques can include, for example, a database search, a database merge, GREP, AGREP, SQL, using a key field in the tables to speed searches, sequential searches through all the tables and files, sorting records in the file according to a known order to simplify lookup, and/or the like. The association step can be accomplished by a database merge function, for example, using a “key field” in pre-selected databases or data sectors. Various database tuning steps are contemplated to optimize database performance. For example, frequently used files such as indexes can be placed on separate file systems to reduce In/Out (“I/O”) bottlenecks.

More particularly, a “key field” partitions the database according to the high-level class of objects defined by the key field. For example, certain types of data can be designated as a key field in a plurality of related data tables, and the data tables can then be linked on the basis of the type of data in the key field. The data corresponding to the key field in each of the linked data tables is preferably the same or of the same type. However, data tables having similar, though not identical, data in the key fields can also be linked by using AGREP, for example. In accordance with one embodiment, any suitable data storage technique can be utilized to store data without a standard format. Data sets can be stored using any suitable technique, including, for example, storing individual files using an ISO/IEC 7816-4 file structure, implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that can include fractal compression methods, image compression methods, etc.

One skilled in the art will also appreciate that, for security reasons, any databases, systems, devices, servers or other components of the system can consist of any combination thereof at a single location or at multiple locations, wherein each database or system includes any of various suitable security features, such as firewalls, access codes, encryption, decryption, compression, decompression, and/or the like.

Any of the communications, inputs, storage, databases or displays discussed herein can be facilitated through a website having web pages. The term “web page,” as it is used herein, is not meant to limit the type of documents and applications that might be used to interact with the user. For example, a typical website might include, in addition to standard HTML documents, various forms, JAVA® APPLE®, JAVASCRIPT, active server pages (ASP), common gateway interface scripts (CGI), extensible markup language (XML), dynamic HTML, cascading style sheets (CSS), AJAX (Asynchronous JAVASCRIPT and XML), helper applications, plug-ins, and the like. A server can include a web service that receives a request from a web server, the request including a URL and an IP address (123.56.192.234). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, AJAX, WSDL, and UDDI. Web services.

The system and method can be described herein in terms of functional block components, screenshots, optional selections, and various processing steps. It should be appreciated that such functional blocks can be realized by any number of hardware and/or software components configured to perform the specified functions. For example, the system can employ various integrated circuit components, e.g., memory elements, processing elements, logic elements, lookup tables, and the like, which can carry out a variety of functions under the control of one or more microprocessors or other control devices. Similarly, the software elements of the system can be implemented with any programming or scripting language, such as C, C++, C#, JAVA®, JAVASCRIPT, VBScript, Macromedia Cold Fusion, COBOL, MICROSOFT® Active Server Pages, assembly, PERL, PHP, awk, and Python. Visual Basic, SQL Stored Procedures, PL/SQL, any UNIX shell script, and extensible markup language (XML) with the various algorithms being implemented with any combination of data structures, objects, processes, routines, or other programming elements. Further, it should be noted that the system can employ any number of conventional techniques for data transmission, signaling, data processing, network control, and the like. Still further, the system could be used to detect or reduce the risk of security issues with a client-side scripting language, such as JAVASCRIPT, VBScript, or the like.

These computer program instructions can be loaded onto a general-purpose computer, special-purpose computer, or other programmable data processing apparatus to produce a machine, such that the instructions that execute on the computer or other programmable data processing apparatus create means for implementing the functions specified in the flowchart block or blocks. These computer program instructions can also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions can also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special-purpose hardware-based computer systems that perform the specified functions or steps, or suitable combinations of special-purpose hardware and computer instructions. Further, illustrations of the process flows and the descriptions thereof can refer to user WINDOWS®, webpages, websites, web forms, prompts, etc. Practitioners will appreciate that the illustrated steps described herein can comprise any number of configurations, including the use of WINDOWS®, webpages, web forms, pop-up WINDOWS®, prompts, and the like. It should be further appreciated that the multiple steps, as illustrated and described, can be combined into single web pages and/or WINDOWS® but have been expanded for the sake of simplicity. In other cases, steps illustrated and described as single process steps can be separated into multiple web pages and/or WINDOWS® but have been combined for simplicity.

Phrases and terms similar to “currency account” can include any account that can be used to facilitate a financial transaction. Phrases and terms similar to “financial institution” or “account issuer” can include any entity that offers transaction account services. Although often referred to as a “financial institution,” the financial institution can represent any bank, lender, or other types of account-issuing institutions, such as credit card companies, card sponsoring companies, or third-party issuers under contract with financial institutions. It is further noted that other participants can be involved in some phases of the transaction, such as an intermediary settlement institution.

The term “non-transitory” is to be understood to remove only propagating transitory signals per se from the claim scope and does not relinquish rights to all standard computer-readable media that are not only propagating transitory signals per se. Stated another way, the meaning of the terms “non-transitory computer-readable medium” and “non-transitory computer-readable storage medium” should be construed to exclude only those types of transitory computer-readable media that were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems and any elements that can cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone can be present in an embodiment, B alone can be present in an embodiment, C alone can be present in an embodiment, or that any combination of the elements A, B, and C can be present in a single embodiment; for example, A and B, A and C, B and C, or A and B and C.

Although the disclosure includes a method, it is contemplated that it can be embodied as computer program instructions on a tangible computer-readable carrier, such as a magnetic or optical memory or a magnetic or optical disk. All structural, chemical and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications can be made while remaining within the spirit and scope herein.

It is understood that although a number of different embodiments of the systems and methods have been illustrated and described herein, one or more features of any one embodiment can be combined with one or more features of one or more of the other embodiments, provided that such combination satisfies the intent of the present invention.

While a number of exemplary aspects and embodiments of the systems and methods have been discussed above, those of skill in the art will recognize certain modifications, permutations, additions, and sub-combinations thereof. It is, therefore, intended that the following appended claims and claims hereafter introduced are interpreted to include all such modifications, permutations, additions, and sub-combinations as are within their true spirit and scope, and no limitations are intended to the details of construction or design herein shown.

What is claimed is:

1. A system for non-custodial digital asset management, the system comprising:
an ETP platform for managing digital assets; and
a database including a non-transitory computer-readable medium including code and a controller that executes the code, the controller enabling communication between a user device and the ETP platform, the database being connected to an encrypted tunnel that is configured to protect against unauthorized access to the system.

2. The system of claim 1 further comprising a smart contract that is connected to the database.

3. The system of claim 1 wherein the ETP platform provides real-time portfolio updates, the portfolio updates allowing for continuous alignment with market conditions and investment strategies.

4. The system of claim 1 further comprising a blockchain that is integrated with the ETP platform.

5. The system of claim 1 wherein the ETP platform includes compliance and monitoring tools that increase the likelihood that all transactions with the system comply with regulatory requirements by continuously monitoring activities within the system.

6. The system of claim 1 wherein the ETP platform includes an active rebalancing algorithm that is configured to analyze (i) market data and (ii) portfolio weights, and to generate updated allocation instructions to maintain target asset distributions.

7. The system of claim 1 wherein the ETP platform includes real-time data integration and aggregation.

8. The system of claim 1 wherein the database includes a distributed database that stores one of (i) information related to user portfolios, (ii) market data, (iii) compliance records (e.g., KYC/AML), and (iv) transaction histories.

9. The system of claim 1 wherein the database includes an encrypted partition that is configured to store encrypted user data using a cryptographic key.

10. The system of claim 1 wherein the ETP platform is configured to rebalance digital assets according to an investment strategy.

11. A system for non-custodial digital asset management, the system comprising:
an ETP platform for managing digital assets;
a database including a non-transitory computer-readable medium including code and a controller that executes the code, the controller enabling communication between a user device and the ETP platform, the database being connected to an encrypted tunnel that is configured to protect against unauthorized access to the system; and
a smart contract that is connected to the database via an application programming interface.

12. The system of claim 11 wherein the smart contract is configured to (i) enforce business workflows in a decentralized manner, (ii) keep track of exchange accounts, rebalancing, and asset transactions, and (iii) orchestrate transfers within the system.

13. The system of claim 11 further comprising a blockchain that is integrated with the ETP platform, the smart contract residing on the blockchain.

14. The system of claim 11 wherein the smart contract autonomously governs workflow of the system by supporting execution and recording of various actions including one of (i) account registration, (ii) asset rebalancing, and (iii) asset purchases.

15. The system of claim 11 wherein the smart contract can be completed by a digital signature using crypto operations and a private key.

16. The system of claim 11 wherein the application programming interface includes an application programming interface gateway that is configured to aggregate real-time data.

17. The system of claim 11 further comprising cloud storage that interconnects a user device and the database.

18. The system of claim 11 further comprising a dashboard that is connected to the ETP platform, the dashboard being viewable by a user to view their investments and portfolio.

19. The system of claim 11 further comprising an exchange that allows for the transacting of digital assets within the ETP platform.

20. A system for non-custodial digital asset management, the system comprising:
an ETP platform for managing digital assets;
a database including a non-transitory computer-readable medium including code and a controller that executes the code, the controller enabling communication between a user device and the ETP platform, the database being connected to an encrypted tunnel that is configured to protect against unauthorized access to the system, the database including a distributed database that stores one of (i) information related to user portfolios, (ii) market data, (iii) compliance records (e.g., KYC/AML), and (iv) transaction histories;
a smart contract that is connected to the database via an application programming interface, the smart contract autonomously governing workflow of the system by supporting execution and recording of various actions including one of (i) account registration, (ii) asset rebalancing, and (iii) asset purchases; and
a blockchain that is integrated with the ETP platform, the smart contract residing on the blockchain.
